(19) United States
(12) Patent Application Publication
(10) Pub. No.: US 2010/0332258 A1
(43) Pub. Date: Dec. 30, 2010

(54) Clinical Trial Navigation Facilitator

(75) Inventors: Deborah Vollmer Dahlke, Austin, TX (US); Chris Capelli, Houston, TX (US)

Correspondence Address: VINSON & ELKINS, L.L.P., FIRST CITY TOWER, 1001 FANNIN STREET, SUITE 2500, HOUSTON, TX, 77002-6760, US

(73) Assignee: Texas Healthcare & Bioscience Institute

(21) Appl. No.: 12/779,829

(22) Filed: May 13, 2010

Related U.S. Application Data
(60) Provisional application No. 61/178,161, filed on May 14, 2009.
(60) Provisional application No. 61/177,700, filed on May 13, 2009.

(51) Int. Cl. G06Q 50/00; G06Q 90/00

(52) U.S. Cl. 705/3; 705/2; 705/500

(57) ABSTRACT

A method of improving clinical trial recruitment and retention includes creating patient trial scores based on ranking of patient traits or characteristics, creating patient clusters based on statistical similarity and allocating clinical trial navigation resources to patients groups based on need as indicated by cluster rankings.

### BACKGROUND OF THE INVENTION

Patient recruitment and retention currently represents a critical bottleneck in clinical research and drug development. Nearly all new therapies and treatments are tested through clinical trials, thus the timely completion of trials is critical in bringing new therapies to market. Testing of new therapies in sufficient numbers of the patients affected by the disease and the target drug being evaluated is necessary to ensure the generalization of the results. For example, in cancer clinical trials, studies indicate that only a small portion of patients, about 3 to 5 percent of the estimated 10.1 million adults with cancer in the U.S., participate in clinical trials. The composition of the patients participating in these trials does not mirror the racial and ethnic composition of the US, nor does it mirror the populations with the highest rates of cancer. As an example, among those who participated in clinical trials for cancer between 1995-1999, fewer than 10 percent collectively represented African Americans, Hispanics/Latinos, Asian/Pacific Islanders and Native Americans. The exclusion or under-representation of specific types of patient populations may mean that researchers fail to consider or do not learn about potential differences in drug dosage or efficacy among different groups.

Patient recruitment is one of the largest and most costly elements in drug development, consuming nearly 27% of the total cost of the drug development process—approximately US$5.9 billion. More than half of all US clinical trials from 1993 to 1998 were delayed by at least a month and the failure to get enough patients in time accounts for 85 to 95 percent of all days lost during clinical trials. In addition to recruitment delays, trial dropout rates of 15-40% in clinical trials are not uncommon, and 86% of all U.S. clinical studies fail to recruit the required number of subjects on time. Participant recruitment to clinical trials is considered by many to be the most difficult and challenging aspect of clinical trials, with flaws in recruitment identified as one of the main reasons for the failure of clinical studies.

These delays and failures result in increased costs for drug development, delays in getting new life-saving drugs to market, and greater overall prices for new therapies.

Several systems and methodologies for finding and matching patients to available clinical trials have been developed. Some of these systems use existing medical records matched against databases of open and recruiting clinical trials. These systems are in use in offices, hospitals and clinics Patient self-referral tools to match to specific or multiple trials are also available via the Internet and through operator-assisted call center systems. However, these methods stop short of providing the researcher and the patient with useful information about the patients' likelihood of applying to and, once enrolled, remaining compliant and staying on the trial. Once matched with a trial, existing systems and processes generally do not maintain communication with potential applicants nor provide ongoing patient communication and support. Personalized patient case management and communications by trained Patient Navigators are especially useful in supporting minority and underserved patients as they frequently have need of additional services while on trial. As it is costly to provide navigation and personalized communication for patients considering and participating in trials, it is important and useful to determine how much assistance different types of patients will need or request. Such needs may differ according to various factors such as the defined target patient groups or the design of the trial.

Therefore, there is a need to provide a process with flexibility in defining patient and trial participant segmentation rules and a scoring method to assist in segmenting patients into groups or clusters. As part of this system, it is desirable to provide for a system that segments patients into groups that indicate specific needs or characteristics that affect likelihood of applying to and, once enrolled, staying in a trial. Such segmentation can be accomplished by establishing a scoring system based on a set of factors including age, marital status, race/ethnicity, socioeconomic status determined by proxy, and prior trial experience combined with self-reported characteristics or requirements. Patients self-report on specific questions related to the level and type of personalized services or assistance they find helpful or necessary in their application to and participation in a trial or observational study. The disclosure improves on prior art by providing a rules-based patient segmentation system that can be used to cluster groups of patients in order to address their needs. The designed system can also be used to track the performance of patient navigation and communication tools over time to improve the process.

Since a clinical trial participant's status and concerns may change and shift with time and circumstances, it is also important to provide methods and systems for ongoing communication and as the basis for changes or adjustments to the scoring system. Increasingly patients and their caregivers use the Internet to seek information and share their experiences. Secure, private, online social networking systems can be used for interactive patient communications, for the creation of patient profiles, and to identify and assess areas of patient motivation, psychosocial functioning, and non-medical concerns. Such a social network can also be used to identify and track ongoing or changing needs or requirements for various types of support and service. Data and information gathered from the social network system can be used to change or adapt an individual patient's score for case management and to adjust case management requirements as may be indicated. Combining information collected across multiple patients within a trial or groups can also provide useful indicators about clinical trial sites, areas where treatment protocols may need to be redesigned, adapted, and/or to discover unexpected aspects about particular treatments.

Patients participating in trials are seldom provided with an accessible and lasting record of the characteristics used to match that patient with the publicly available inclusion/exclusion characteristics, trial summaries and other trial-specific information that could be used in emergency situations or as a guide and referral in considering future trials. Thus, it is desirable to provide clinical trial applicants and participants with an easy to access and update personal record of their personal history, general trial match characteristics and a summary of publicly available information about the trials they are considering or have participated in.

Traditionally, retention of patients on clinical trials is accomplished using disease management techniques such as follow-up telephone calls. However such outbound calls to patients can be costly, and require use of excessive financial and human resources. As a result, even though the clinical trials using such systems may have sufficient recruitment numbers and achieve some level of success in patient retention, the future benefit may not overcome the current increased costs.

To overcome these issues of costs, a method has been discovered to accelerate clinical trials through improved recruitment and patient retention wherein during recruitment of the patients for said clinical trials the patients are segmented based on a retention factor and the resources expended on retaining said patient is based on said retention factor. The idea is that all patients do not need the same level of follow-up. Some patients require more encouragement, education and hands-on activities to maintain their participation in clinical trials than others.

Patients with poor retention factors can be allocated extra resources in terms of telephone calls, visits, literature and educational materials in order to increase and support their retention in the clinical trial. As a result of using an electronic community and ongoing surveys and follow-up via phone or email to develop and update patients' retention factors or scores, a clinical trial can be accelerated and patients on the trial can receive appropriate and helpful attention at the lowest cost.

### SUMMARY OF THE INVENTION

The current disclosure includes methods of improving clinical trial recruitment and retention by allocating resources of a clinical trial navigator or navigation system to allocate more resources to the neediest patients. In the practice of the preferred embodiments, data and traits are collected from patients and used to create patient profiles, and segmentation strategies are devised to rank patients according to factors that may prevent clinical trial retention. After assigning scores to patients, statistical clustering is used to rank clusters of patients from highest to lowest need of resources. By allocating the most resources to the neediest patients, retention of those patients to complete the trial is improved.

The following discussion provides a detailed description of several embodiments of the invention and should not be taken to be limiting of the invention itself. This present disclosure generally relates to methods and systems for segmenting and managing patients for clinical trial recruitment based on flexible combinations of patient characteristics to create a retention factor or compliance score. In this embodiment, the method and system used to create, store, and manipulate the patient characteristics can be implemented through a set of machine readable components. The solution set includes the following components, the functionality of which is described in detail.

### BRIEF DESCRIPTION OF THE DRAWINGS

The following drawings form part of the present specification and are included to further demonstrate certain aspects of the present disclosure. The disclosure can be better understood by reference to one or more of these drawings in combination with the detailed description of specific embodiments presented herein.

FIG. 1. A block diagram of an exemplary clinical trial patient recruitment and retention software system consistent with certain embodiments of the present disclosure.

FIG. 2. Data elements use in the creation of patient segments.

FIG. 3. A set of potential member or patient segments and clusters derived from them.

FIG. 4. The process by which one or more segmentation strategies are used to create unique and composite scores and a ranking system for each patient to be used in the allocation of patient navigation resources.

FIG. 5. the process by which patient navigation resources are allocated based on the composite scores and ranks of patients as determined by one or more segmentation strategy.

FIG. 6. The process by which a registered patient/member of the CTN system can access and extract his/her profile information including personal health records and trial summaries for those trials to which he/she matched or is a participant.

### DETAILED DESCRIPTION

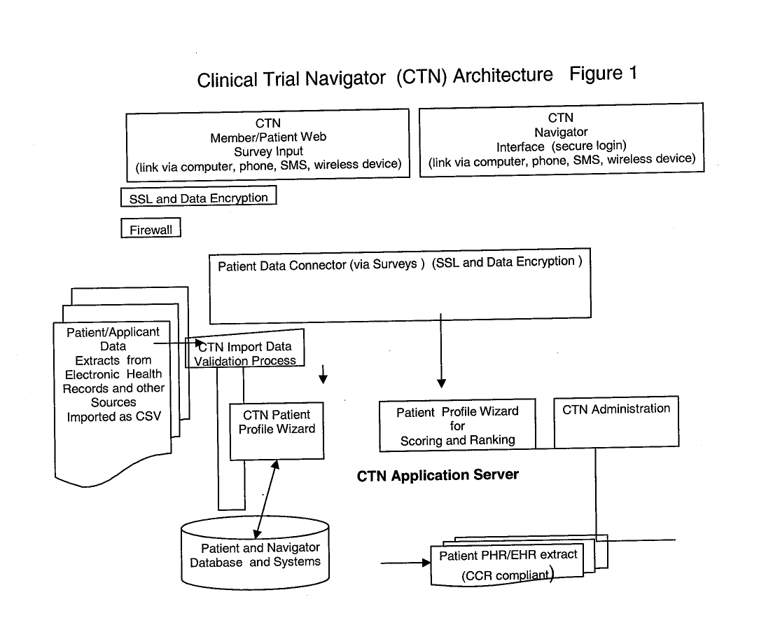

FIG. 1 is a block diagram illustrating an exemplary Clinical Trial Navigator (CTN) architecture consistent with the disclosed embodiments. The architecture can be a computer system including a Web-server application server module such as the Apache HTTP Sever from the Apache Software Foundation. The web server can include the CTN Member Graphical User Interface (CTN GUI) that allows prospective patients or “members” of the network to create personal profiles. The CTN GUI interface also enables administrators to access the patient and member database. The Patient Profile Wizard is used to create groups of patient members and segment and or cluster them according to pre-defined and flexible segmentation rules. The data and information is stored in the propriety patient database, the applications can reside on the web-server or be contained in the application database. The CTN architecture can work on stand-alone basis or can be connected with a hospital or clinic computer network and/or with the world-wide web Internet through the CTN Web Interface.

Clinical Trial Navigator System (CTN) (FIG. 1) is a web-based, software platform for managing CTN members, clinical trial applicants, and participant information and resources. It has features for individual and segment or cluster configurations, electronic data capture (EDC) from multiple sources and capabilities for data retrieval, statistical and content analysis, management and reporting.

The CTN solution and architecture are designed to support healthcare information regulations and guidelines for patient-centric web-based health information, including open sourced clinical trial management systems, electronic health record systems (EHR) and personal health record (PHR) systems.

Clinical Trial Navigator uses a Continuity of Care (CCR) standard (ASTM Continuity of Care Record, CCR, and Standard-ASTM E2369-05) for health data exchange as part of its Application Programming Interface (API). Since the content of CCR is fixed, it is possible to use a single patient health record template to map the trial applicant information to the CTN System and to use specific archetypes that are part of the CCR as sub-sections of the applicant's information, e.g. gender, race, prior or current medications, genetic markers and so on. Additionally it is possible to use and map subsections of an applicant's information that are not standard CCR data fields, such as socioeconomic proxies, survey responses, or assigned factors. Such mapping can then allow certain data elements to be re-usable across different member and patient health records and open source and compliant EHR or PHR systems to capture and share data. Data can also be entered into the CTN using data tables constructed as comma separated values which can be mapped CTN client data fields.

The primary application modules for Clinical Trial Navigator (CTN) include the following:

CTN Member Web Interface: This module of CTN is a flexible and adaptable graphical user interface (GUI) that allows for the presentation and selection of choices, answers and menus that are displayed to and captured from potential CTN members, trial applicants, patients, caregivers and healthcare professionals seeking to match patients to trials. The GUI is operable on networks, web-based computer systems, and wireless and phone-based system interfaces such as smart phones, Blackberries™ and other systems. The GUI has the capability to present questions and interact with the user based on responses to and selection of the various sets of information provided. The user member name, password and agreement to terms and conditions process, once complete, stimulates the system to begin collecting and encrypting data and communicating using the Shared Socket Layer (SSL) such that the users become “members” of the CTN system. Members can then have access to a variety of tools and solutions through this secure and encrypted interface including clinical trial prescreening, the creation of personal profiles, and the ability to engage with other members in discussion groups, chat rooms and bulletin boards. The CTN interface requires its users to explicitly state and ensure that all personal data from members has been acquired and shared with full knowledge of, and agreement to the privacy, terms and conditions and ownership of the data. The CTN Member Web Interface stores the member data into a secure Patient/Member database and can also provide links to other services and information as well as access to contractually acquired tools, solutions and processes from other groups, companies and institutions.

CTN Patient/Applicant Data Connector: This module provides a user-friendly web-based interface for capturing patient information for enrollment from CTN and CTN-certified partner web-based interfaces and networks, including wireless transmissions and smart phone appliances. The CTN Data Capture module, operating in a secure and encrypted SSL mode, can also extract patient applicant and trial participant information from existing Electronic Health Records (EHR) and Personal Health Record (PHR) systems using Continuity of Care Standards to define, filter and extract individual or batch patient or clinical trial study datasets into localized XML data files for storage in the CTN Patient Member Database.

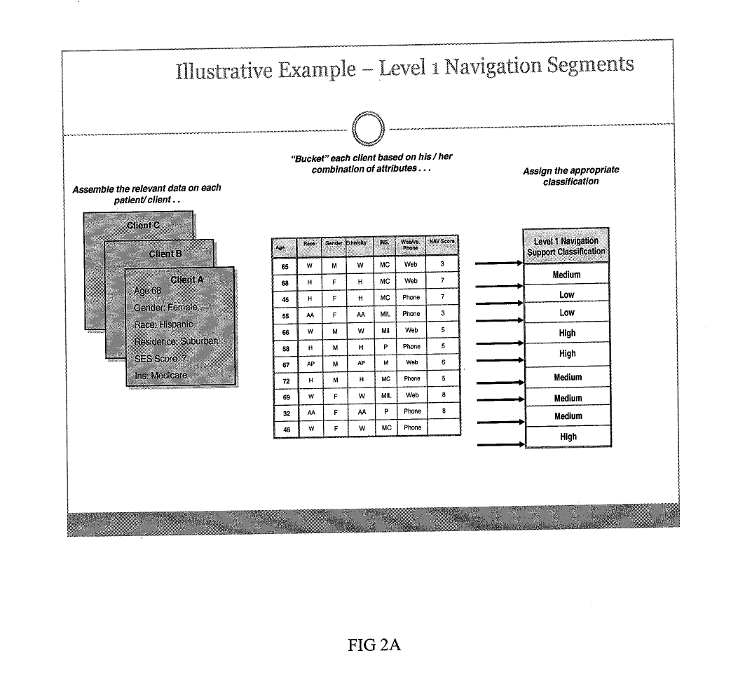

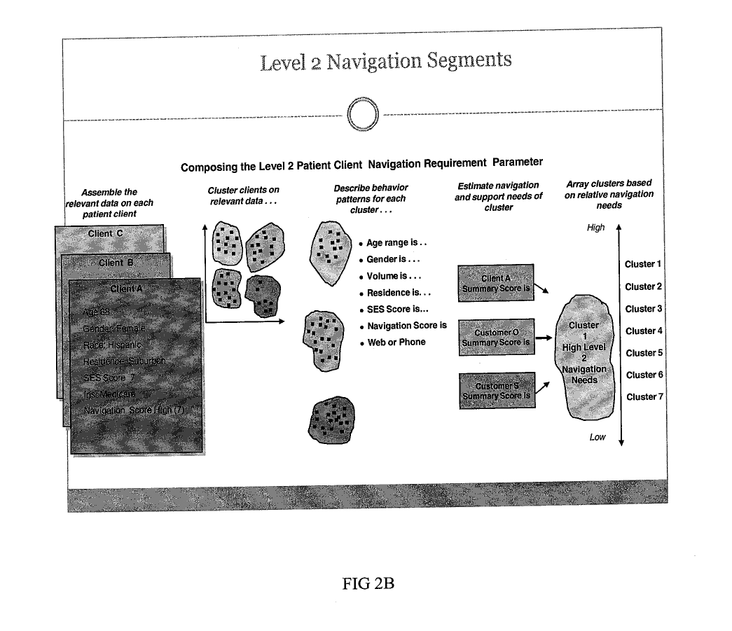

CTN Patient Profile Wizard: This module is used to facilitate configuration, segmentation, clustering and management of individual and groups of members, patient applicants, and other CTN member-participants. CTN Administrators are able to define various trial applicant and trial participant scoring scenarios, and create multiple data and process work flows. The scoring scenarios are developed by describing applicant and participant data elements based on a flexible menu (e.g. age, gender, disease type, stage of disease, prior medical treatments, socioeconomic proxies, physical location, prior trial experience, assistance requirement factors, and so on. (See FIGS. 2 and 3). Scoring scenarios are used to develop and define the various characteristics and information needed to determine the patient scores and what level of patient assistance may be required to assist with enrollment and to provide support for retention in a specific clinical trial. Scoring scenarios may also include trial specific requirements determined by inclusion/exclusion criteria, patient genetic marker profiles or other information. The CTN Patient Profile Wizard has the capability of making calls out to existing web-based databases such as U.S. Census datasets or other online psycho-graphic and demographic data services and analytical programs. Such data is used in creating proxies for patient socio-economic status (SES) and then used in the creation of the retention factor or scoring system.

The Profile Wizard inputs are areas of patient/client information that can be scored and ranked using Likert scales or set scoring patterns in the development of overall patient scores for the allocation of navigation resources. The Likert scale is a well-known scale and is based on questions or items in which a respondent selects an answer from a series of choices that range from choices such as strongly agree as the highest score (5, for example) to strongly disagree as the lowest (1, for example). Intermediate choice such as mildly agree or mildly disagree would receive scores of 4 and 2, respectively in this example. The scores provide CTNS administrators with a very clear image of groups of patients and clients with similar needs and allow for segmentation, grouping and clustering of patients according to navigation needs and other barrier concerns. The overall objective is to make patient/client groupings more valuable and actionable by applying the most effective navigation strategy by type of client and client group, segment or cluster.

Examples of the types of personal information, socio-economic status and health information that may be collected, from various inputs such as surveys, electronic medical records, or captured from phone or in person conversations with patients and navigators are listed below. Each of these types of information may be associated with a set of values for scoring and ranking. The types of information include, but are not limited to the following:

1) Client/patient registration data (e.g., name, address, phone numbers, age, income, race/ethnicity, marital status, education level). For example, patient information for income level or marital status may be important indicators for navigation assistance and the scores for these areas may be allocated such that low income levels are associated with higher scores, or that marital status of unmarried or divorced living alone rank higher than married responses.

2) Financial Barriers to clinical trials (e.g., lack of insurance, inadequate insurance, insurance pre-certification for treatment/trial concerns, difficulty paying bills, need for Medicare/Medicaid enrollment assistance, need for prescription assistance, need help in understanding insurance and financial paperwork, need help in negotiating self-pay service payments, need for medical equipment or supplies (wheelchairs, walkers, dressing) and concerns about citizenship or undocumented status. This type of data can be represented using Likert scales so that patient/clients can self score their barriers in these areas.

3) Transportation needs to apply for and participate in trials (e.g. public transportation needs, taxi, bus, train) Private Transportation needs and costs (e.g., car, airplane, wheelchair van, ambulance, gas and parking funds. (Likert scales)

4) Physical needs such as childcare or eldercare, housing near a clinical trial site, food needs, clothing needs, vocational support, extended home or hospice care needs. (Likert scales)

5) Mistrust/communication/cultural barriers such as mistrust of doctors, fear of clinical research, primary language other than English, poor health literacy, fear of disease, family issues, modesty issues and so on. (Likert scales).

In the practice of the disclosure, administrators and users can easily establish and test various strategies for scoring, ranking and clustering using the Profile Wizard tools. This allows users to test their strategies against the reality of the patient needs and requirements for navigation and retention in trials. Additionally, individual patients or groups of patients' characteristics may change over time, requiring adjustments to scoring strategies or even clustering analysis. Navigators and administrators may find that the results of patient navigation as tracked for time to resolution and costs of navigation may differ from the estimates based on the initial strategies. As a result, administrators may determine that the strategies and scoring scenarios need to be revisited and adjusted. Another example might be a group of patients that are enrolled into a trial and the Navigator identifies a need to re-score several individuals for counseling for insurance filing and also for transportation needs. Patients can be re-surveyed on specific navigation needs or the Navigator can query the patients for re-scoring and the resulting data and analyses allows the patients to be re-grouped into different clusters and the navigation requirements allocated appropriately.

Using the Patient Profile Wizard, the individual member can request access to download his/her own individual profile by agreeing to certain terms and conditions. The Profile Wizard enables the configuration of the individual patient profile and data set and allows the patient member to download the data set as an XML file or as a pre-configured, comma separated values (CSV) data set.

CTN Analysis and Patient Profile Manager. The main function of this module uses the scoring scenarios created in the CTN Profile Wizard to create and report on the numerical and statistical analyses of the CTN member and/or patient participant groups using pre-programmed outputs. Examples of the pre-programmed outputs include tables, bar-charts, pie charts, histograms and plotted reports on the patient individual, group or cluster data. The original and calculated data appears in a spreadsheet format and can be saved by the administrator or users to a local hardrive in Microsoft Excel or CSV format.

Numerical profile fields from patient/client data inputs are used in the process of scoring and ranking. For example the mean, median, minimum and maximum and the coefficient of variation may be used to assess and allocate combined scores from the profile wizard input fields. The coefficient of variation defined as CV %=(SD/Xbar)100 is a figure representing what percentage the standard deviation is of the mean. The larger the CV, the more diverse and variable the data, or in the current examples, the scores. CV is used as a measurement of the importance of a barrier score or field that then can be used to effectively segment the patients/clients. Thus, a patient/client's profile or record fields can be ordered by CV in descending order to assist users in field selection or in segmentation.

The disclosed methods and systems can be used to calculate the relative frequency of each category and the information of each profile fields for a group of patient clients. Let N_{ci} be the total number of observations that belong to a barrier category ci let n be the total number of observations in the patient client group.

The relative frequency of category ci is defined as

$${f}_{ci} = \frac{{n}_{ci}}{n}$$

The entropy is defined as

$$E = {\sum }_{- i} {f}_{ci} \cdot In ( {f}_{ci} )$$

The larger the entropy, the more diverse and variable are the data (or the scores in this case). Similar to CV, the profile fields for elements such as types of barriers, types of cultural mistrust, race, gender or ethnicity can have numerical scores associated from the Likert scales or scoring ranges. The client/patient profile fields can be ordered by magnitude of entropy in descending order to assist the administrator or navigator in determining what fields to select for segmentation, scoring or statistical clustering.

The Patient Profile Wizard enables administrators and navigator users to conduct rule-based statistical algorithms that estimate the statistical distance between the individual and unique patient profiles to measure the similarity between patients/clients and then group them into segments or clusters. Patient Profile Wizard can be used for K-means and neural network (Kohonen Net) clustering (see below). The program produces summary statistics as well as charts and reports and dashboards to describe the attributes of the patient/client segments and clusters. Administrators and users are able to select between performing segmentation and clustering analysis on data as shown below in the K-means example or they may also extract the data and use statistical tools for neural nets programs.

K means clustering allows the program of perform unsupervised learning. That is, the system will learn on its own, using the data (learning set), and will classify the objects into a particular class—for example, if our class (decision) attribute is Navigation Need and its values are high, medium, low—these will be the classes. They will be represented by cluster1, cluster2, etc. K means uses a partitional clustering approach wherein each cluster is associated with a center point and each point is assigned to the cluster with the closest center point or centroid. The centroid is typically the mean of the points in the cluster and closeness may be measured using entropy or CV as described above. In the example below, the administrator used three data sources, Likert scale scores for ranking fear of doctors and medical mistrust a characteristic for transportation type (urban, rural, suburban with the rural being ranked as the highest need characteristic.

### Navigation Needs Learning Set for K-Means

| | | | | Navigation |
|---|---|---|---|---|
| | Fear of | | Transportation Type | Need |
| | Doctors | Mistrust | (urban/rural/suburban | values |
| x1 | 8 | 12 | R | High |
| x2 | 6 | 8 | R | High |
| x3 | 3 | 4 | U | Medium |
| X4 | 3 | 5 | S | Medium |
| X5 | 3 | 4 | S | Medium |
| X6 | 4 | 4 | U | Medium |
| X7 | 4 | 3 | U | Medium |

The clusters are created by plotting the objects from the database into space in which each patient attribute is one dimension of space. So for three attributes, the data is plotted in three dimensions. Once the objects are plotted, the methods include calculation of the distance between patients in the space plot and the ones closest to each other are grouped into a cluster. Those clusters that are farthest from the point of origin (0,0,0) on the plot have the greatest navigation needs for the clinical trial. Clusters are thus ranked according to need for resource allocation to recruit and retain patients within the clusters.

CTN Administration: This module allows overall CTN system oversight, auditing, security setting, configuration, user account management, and reporting by administrators. This section also enables compliance with regulatory guidelines such as HIPPA and 21 CFR Part 11 (Code of Federal Regulations) by including differentiated user roles and privileges, passwords and user authentification security, electronic signatures, Secure Socket Layer (SSL) encryption and de-identification Protected Health Information (PHI).

### Embodiments of the Clinical Trial Navigator System

One embodiment of the use of the CTN system is a method of accelerating trial enrollment and ensuring a broader set of patient subjects to support a more representative patient population of prospective patients likely to apply to and remain in said clinical trial. This is achieved by segmenting prospective patients during the recruitment phase wherein the patients are segmented into multiple groups and can be clustered based on a retention factor or score. Information gathered from the patients, the patient's electronic medical records or some combination of data sources can include age, marital status, race/ethnicity, socioeconomic status determined by proxy, and prior trial experience combined with self-reported characteristics or requirements.

(See FIG. 3). For example, the following steps can constitute one such process in this embodiment of the system:

At the patient's, caregiver's or healthcare professional's request, a secure password protected membership account is created into a network database or an online community using the CTN Member GUI. In this embodiment the example process includes the following steps:

Creating a unique patient member profile within a secure password protected site to receive and store personal and medical information from the members. (Step 3.00)

The member patient must agree to the CTN Privacy Policy and Terms and Conditions for the use of the system and the use of data and information.* Step 3.01)

Requesting and accepting patient/member permission to re-contact the member by phone, email or other messaging, including live interactions, to get compliance or other information, including responses to survey questions occurs in Step 3.02 which can include communication by phone, email, or web-based forms and surveys.

Step 3.03 occurs with the patient/member's permission and can include access and transfer of the patient's personal and medical data from Electronic Medical Records located at a hospital or physician's office.

Step 3.03 is an optional step that involves geocoding of the member patient address and zip code information by accessing US Census data. This step is used if the patient does not wish to share information on income.

In Step 3.04 one or multiple patient data sets or profiles are created, or updated using pre-defined fields and stored into a propriety database designed to store and manage member profiles and information.

Step 3.05 involves the creation of one or more patient/member segmentation strategies in which scoring factors are allocated to individual patient characteristics such as age, race/ethnicity, SES proxies, marital status, etc.

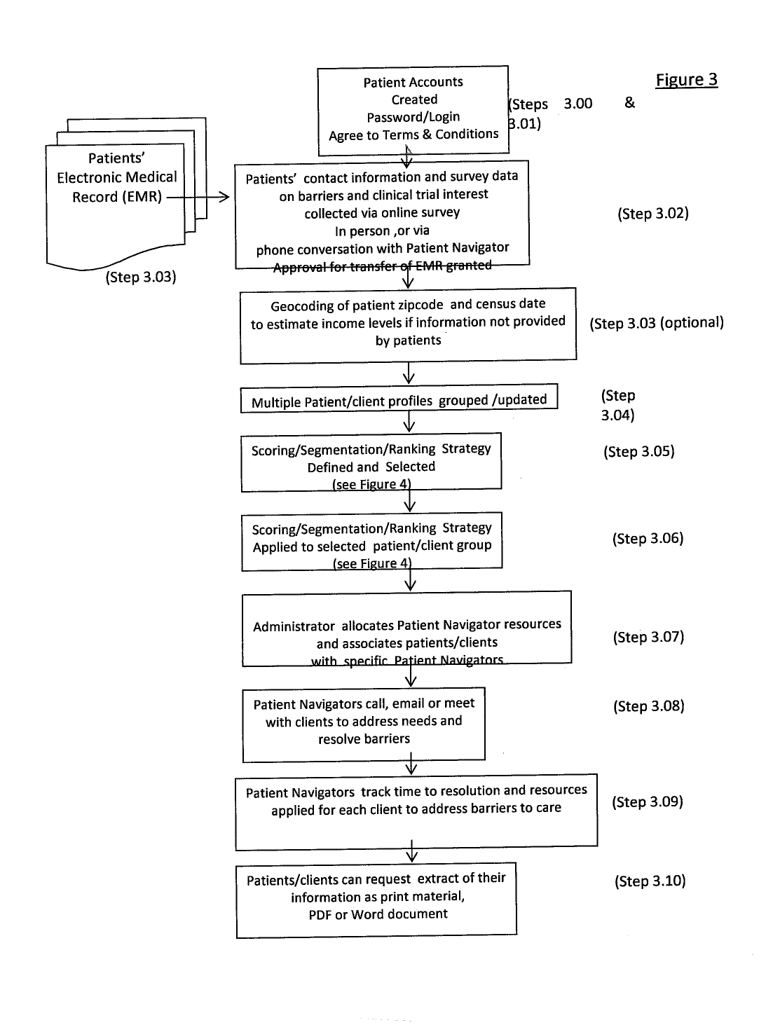

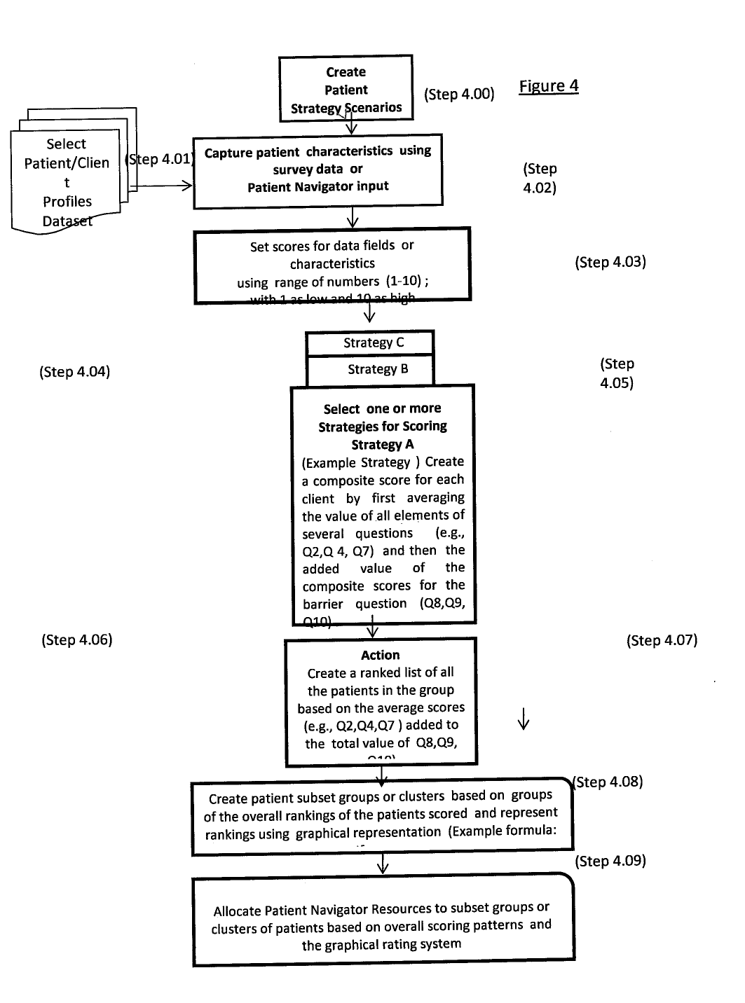

Step 3.06 uses the member/patient profiles and the segmentation strategies to create unique and composite scores and rankings of the patient/members in order to allocate a Navigation Score and to cluster groups of patients by scores. (See FIG. 4)

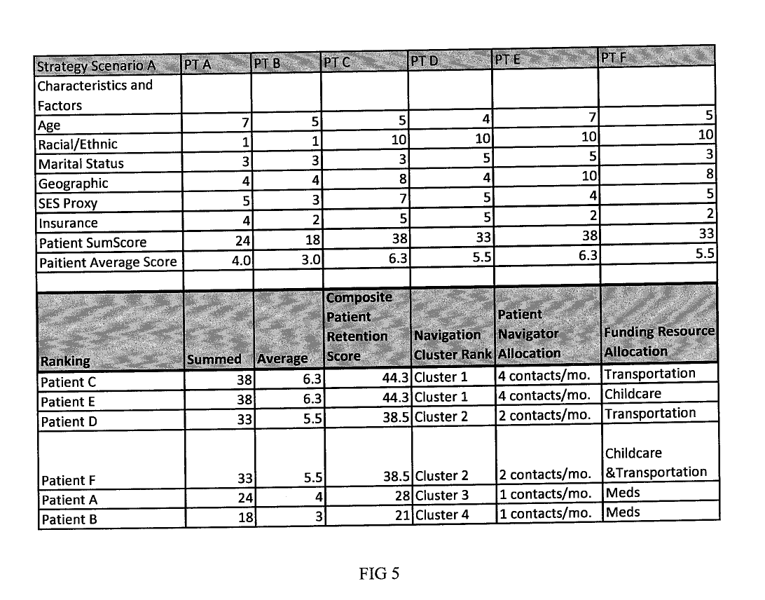

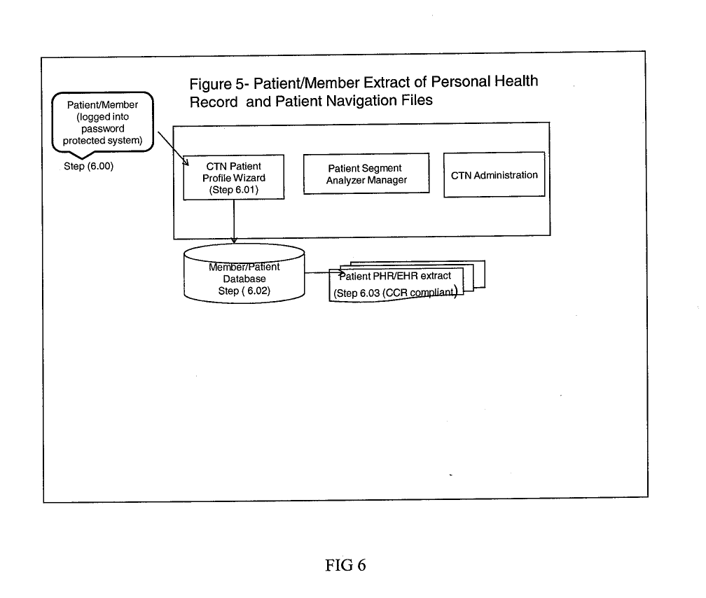

Step 3.07 allocates clinical trial navigator resources based on the patient scoring system for phone, email and voice communication to assist the patient/members in their search for appropriate trials and to support communication for those patients who enter a trial. (see FIG. 5)

Step 3.08 is the operation of the patient navigators who can call, email or SMS text patients to assist them in their enrollment and participation in a clinical trial.

Step 3.09 provides a process to update and change patient profiles, either by the patients or the clinical trial navigators to reflect changes in status, scores or other information stored in the patient profile and database. Examples of tracked information include allocation of resources to address patient barriers to trial participation. Patient Navigators can also track the time expended in client service activities.

Step 3.10 is the process whereby patients can request using the CTN Profile Wizard as an extract of their information in the form of a Personal Health Record. (See FIG. 6)

The patient data collection process can be conducted so that it satisfies the requirements of Health Information Portability Assurance and Accommodation Act of 1996 (HIPPA) and/or privacy laws dictated by some other law or organization.

The data for segmentation can differ in various different studies and different requirements in other embodiments to allow for flexibility in designing the patient and trial participant segments. Segmentation strategies can be used singly or in combination to develop composite scores for each patient. Examples of segmentation strategies include those which allocate higher scores for patients most likely to need patient navigation resources due to socio-economic status, age, marital status or race/ethnicity. Other segmentation strategies can be developed based on patient medical information such as tests for molecular targets or other individual genetic characteristics. In other embodiments, segments can be based on ecological, environmental, or demographic factors.

Another embodiment of the system is a method of accelerating clinical trials through improved recruitment and retention of candidates by supporting interactive patient and caregiver communication using social networking via computer mediated communications. Such networks can be used for various tasks and activities to support the patient recruitment and retention including the creation of personal profiles, bulletin boards, discussion groups and instant messaging via computer, mobile phone or other wireless devices. The data collected through such communications systems can be used to adapt or change patient retention scores.

An example of the process includes the following steps:

At the patient, caregiver or healthcare professional's request, creating secure password protected membership accounts for membership to an online community.

Receiving personal and medical information from the members.

Receiving permission to contact the members by phone, email or other messaging, including live interactions, to get compliance information and to share information about current or prospective trials or other events such as educational sessions.

Gaining agreement from the members for the terms and conditions under which the online community operates.

Utilization of various and multiple online social networking technology such as patient or caregiver profiles, surveys, discussion groups, chat rooms and sharing of online video or text-based materials.

Analysis of content or socio-demographic information captured in the online communication systems to create segments and/or clusters of patients in order to define groups or create scoring mechanisms that indicate a need for action or activity to support enrollment or sustain patient retention for a specific trial or group of trials.

An additional embodiment of the system enables the member patient to view his/her data profile and information contributed and captured in the system including publically available data on any trials to which the patient is a pre-screened match or an active participant. Such patient profiles can be viewed online, via computer terminal or wireless device and the patient can choose to share all or selected portions of such information with healthcare professionals or others via the creation of a visitor password. All rights and ownership of information collected or analyzed by the system remains the property of the system operators. However, the patient can be authorized to print, extract or download copies of portions of information in their profiles.

### Description of the Patient Segmentation and Scoring System for Navigation (FIG. 4)

The process flow illustrated in FIG. 4 shows the method for creating multiple patient segmentation strategies, creating individual and composite scores for each patient, and the clustering of patients into subsets or groups in order to allocate navigation resources.

The flowchart begins with step 4.00, the creation of one or more patient segmentation strategies. The strategies can include strategies based on behavioral metrics, disease stage, demographic, racial/ethnic, or psychographic characteristics. A scoring system can be allocated to the various characteristics in the individual segmentation strategies.

Once single or multiple segmentation strategies are constructed, the characteristics to be evaluated are allocated a scoring factor (e.g. geographic location: rural=5; suburban=4, urban=3, inner city=5). The segmentation strategies are then implemented by accessing the selected member/patient profiles and data sets from the patient data base (Step 4.01). One or more segmentation strategies can be run against the patient profiles to create unique scores for each patient/member in each of the segmentation strategies (Step 4.03) In Step 4.04 composite scores for each patient are created, if desired. The patient score can be derived from only one strategy or a composite score can be generated by averaging the value of the rankings in the different segmentation strategies. The composite score can alternatively be created (Step 4.05) by combining or adding the scores from one or multiple segmentation strategies. In Step 4.06, a ranked list of all the member/patients' scores resulting from the averaging process (Step 4.06) is created. In Step 4.07, a ranked listing is created based on the value of the each unique patient's combined or added scores.

Step 4.08 creates an overall member/patient score for each patient based on one of the scoring sets (Step 4.06 or Step 4.07) or a combination of both composite scores, Step 4.09 creates clusters or groups of patient/members based on one of the scoring sets or on a combination of both score rankings. Based on these scores, patient navigation and communication resources are allocated to sub groups or clusters of patients.

Description of Allocation of Clinical Trial Navigation Resources based on Patient Scoring, Ranking and Clustering Processes.

The diagram in FIG. 5 shows the process by which patients' composite scores are created by summing or averaging numerical factors associated with a set of characteristics selected as part of a given segmentation scenario.

In FIG. 5, patient summed and average scores are added together to create a composite patient retention score. In this example of segmentation strategy (Strategy A) factors for racial/ethnic characteristics and geography received higher scoring numbers. For example, Hispanic/Latino and African American characteristics scores were greater than those of Caucasians. Factors for rural and suburban were higher in this scenario than factors for inner city or urban residents. The composite score can be composed of combinations of averages and the total sum scores for each patient based on response to surveys or questions posed by Patient Navigators and is considered a Patient Retention Score Based on this patient retention score's value, the patients are rank ordered and grouped into clusters. Patient clinical trial navigator resources for contacting the patients and financial resources for transportation, child care or medications not provided by the trial are then allocated on the basis of the rank-ordered clusters or subsets of patients.

### Description of Patient Profile and Personal Health Record Data Extract (FIG. 6)

The flowchart in FIG. 6 describes the process whereby a registered member/patient of the Clinical Trial Navigation system can retrieve personal information from his/her member profile stored in the CTN patient/member database and extract that information for his/her personal use.

In FIG. 6.0, the patient/member logs into the system's secure socket layer using his/her password and accesses the Patient Profile Wizard. The Patient Profile Wizard includes a box or a command that allows the logged in patient to access his/her profile information Step 6.01) The profile can contain information submitted by the patient, information accessed and collected from surveys, the patient's electronic medical record from another system and information from the CNS system regarding summaries of clinical trials to which the patient is a match or in which the patient is participating. The patient can select from this information which data he/she wishes to extract and download. The patient can be asked to review and agree to the CNS system terms and conditions before the download can occur. Once the patient has agreed to these terms, the CNS system accesses the patient's information from the Patient/Member database (Step 6.02) to create a file for downloading. The patient can select from a variety of formats for the download of his/her profile information.

While particular embodiments of the invention and method steps of the invention have been described herein in terms of preferred embodiments, additional alternatives not specifically disclosed but known in the art are intended to fall within the scope of the disclosure. Thus, it will be apparent to those of skill in the art that variations may be applied to the devices and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

### REFERENCES

Elting L S, Cooksey C, Bekele B N, et al. Generalizability of cancer clinical trial results: prognostic differences between participants and non participants. Cancer. Jun. 1, 2006; 106(11) 2542-2458.
Freiedman M A, Cain D F. National Cancer Institute sponsored cooperative clinical trials. Cancer. May 15, 1990; 65(10 Suppl): 2376-2382.
B. Evelyn et al., Participation of racial/ethnic groups in clinical trials and race-related labeling: a review of new molecular entities approved 1995-1999, 93 (12 Supp.) J. NAT MED. ASS'N 18D (2001)/
Rowe, J C, Elling, M G, Hazelwood J G, and Zakary, R; A Cure for Clinical Trials; McKinsey Quarterly, May 2002, Sourced via web Dec. 16, 2008 at http://www.mckinseyquarterly.com/Health Care/Pharmaceuticals/A_cure_for_clinical_trials_{—}1182?gp=1
D. L. Anderson, A Guide to Patient Recruitment—Today's Best Practices and Proven Strategies (CenterWatch Inc., Boston, Mass., 2001).
R. A. Nathan, “How Important is Patient Recruitment in Performing Clinical Trials?” Journal of Asthma, 36, 213-216 (1999).

1. A method of improving clinical trial recruitment and retention comprising:
creating a patient account and electronically storing account information in a computer database;
receiving or retrieving patient personal and medical data directly from patient or through an electronic link to stored medical or personal information and creating one or more patient profiles based on the data received;
creating one or more segmentation strategies in which scoring factors are assigned to individual patient characteristics;
using member patient profiles and segmentation strategies to create composite scores and rankings of patients to allocate a navigation score;
using navigation scores to statistically compare patients and to cluster groups of patients by similarity of scores; and
allocating clinical trial navigation resources to patients based on membership in clusters, in which clusters with higher needs are allocated a higher level of available resources.

2. The method of claim 1, wherein the segmentation strategy comprises allocating higher scores for patients most likely to need navigation resources due to socioeconomic status, age, marital status or race/ethnicity.

3. The method of claim 1, wherein the segmentation strategy comprises allocating higher scores for patients most likely to need navigation resources due to medical information.

4. The method of claim 3, wherein the medical information is a positive test for a molecular target.

5. The method of claim 3, wherein the medical information is an individual genetic characteristic.

6. A method of improving clinical trial recruitment and retention comprising:
allocating clinical trial navigation resources to individual patients or to groups of patients based on a combination of segmentation strategy and clustering comprising:
creating one or more segmentation strategies wherein for each strategy numerical values are assigned to selected individual characteristics;
creating a patient score by combining the numerical values for each patient characteristic;
grouping patients into clusters ranked by need for navigation resources; and
allocating resources to patients in clusters based on the cluster rank to achieve improved clinical trial recruitment and retention.

7. The method of claim 6, wherein a selected segmentation strategy comprises assigning values to patient characteristics or traits within one or more categories selected from patient behavioral metrics, diseases stage, demographic, racial or ethic background and psychographic characteristics.

8. The method of claim 7, where a patient's score is a numerical sum or an average of values for each characteristic in the selected category.

9. The method of claim 7, where a selected patient's score is a composite score calculated by combining or adding scores for the selected patient from a combination of segmentation strategies.

10. The method of claim 6, comprising grouping patients into clusters by statistical analysis of patient scores to measure similarity between patients considered for a clinical trial and placing patients in clusters based on similarity of resource needs.

11. A system for clinical trial navigation comprising computer readable media with software instructions embedded therein in which data is configured in the following modules:
a member web interface comprising a graphical user interface (GUI) display residing on a web server;
a patient or applicant data connector and one or more connecting links to web-based interfaces or networks to electronic health records (HER) and personal health record (PHR) systems configured to retrieve patient information records and one or more databases to store individual or batch patient records;
a patient profile wizard for creating patient profiles and configuration, classification, segmentation or clustering of patient individuals or groups, including development of scoring scenarios;
an analysis manager for analysis of data and creation and reporting of numerical and statistical analysis of profiles; and
an administration module for creation, storing and maintenance of administrative files comprising system oversight, auditing, security setting, configuration, user account management, and reporting by administrators.
